(19) United States
(12) Patent Application Publication
(10) Pub. No.: US 2015/0108841 A1
(43) Pub. Date: Apr. 23, 2015

(54) MULTIFUNCTIONAL POWER SUPPLY DEVICE

(71) Applicant: STUDIO WEBER + ASSOCIATES, Minneapolis, MN (US)

(72) Inventors: Jeffrey Allen Weber, Golden Valley, MN (US); John Kenneth Blomstrom, Minneapolis, MN (US)

(21) Appl. No.: 14/520,959

(22) Filed: Oct. 22, 2014

Related U.S. Application Data
(60) Provisional application No. 61/894,187, filed on Oct. 22, 2013.

(51) Int. Cl. H02J 5/00; H01R 25/00

(52) U.S. Cl. CPC H02J 5/00; H01R 25/006
USPC 307/31

(57) ABSTRACT

Embodiments of the invention include multi-functional power supply devices and related methods. In an embodiment, the multi-functional power supply device can include a base monument and a detachable accessory module. The base monument can include a first housing, an integrated power and support socket, an internal circuitry, AC electrical outlets, and DC electrical outlets. The detachable accessory module can include a second housing and an integrated power and support plug. The detachable accessory module can be configured to fit on top of the base monument. Other embodiments are also included herein.

This application claims the benefit of U.S. Provisional Application No. 61/894,187, filed Oct. 22, 2013, the content of which is herein incorporated by reference in its entirety.

### FIELD OF THE INVENTION

The present invention relates to multi-functional power supply devices and related methods.

### BACKGROUND OF THE INVENTION

The variety of available personal electronic devices continues to expand rapidly. By way of example, a TV and/or a stereo might have been the extent of home electronics in past times. However, now homes are commonly filled with computers, tablets, smart phones, smart TVs, Internet connected devices, DVD and BLU-RAY players, wireless speakers, programmable universal remote controls, hand held video game players, video game consoles, and the like. The same trend exists with office electronics as well.

One common requirement for all electronic devices is the need for electrical power. Even most electronic devices with their own battery must be plugged in periodically. Electrical power is distributed throughout most buildings as AC current. Electrical power is typically accessed through wall outlets. Power extension cords and/or power strips are frequently used to either extend the distance of power availability or to multiply the number of outlets available for plugging things in.

### SUMMARY OF THE INVENTION

Embodiments of the invention include multi-functional power supply devices and related methods. In an embodiment, the invention includes a multi-functional power supply device. The multi-functional power supply device can include a base monument and a detachable accessory module. The base monument can include a first housing, an integrated power and support socket, internal circuitry, AC electrical outlets, and DC electrical outlets. The first housing can include a top surface. The integrated power and support socket can include electrical contacts. The internal circuitry can include a power rectifier, or similarly functioning device, to convert AC electricity to DC electricity. The integrated power and support socket can be disposed on the top surface of the first housing. The internal circuitry can be disposed within the first housing. The rectifier can be disposed within the first housing. The AC electrical outlets can be disposed on the surface of the first housing. The DC electrical outlets can be disposed on the surface of the first housing.

The detachable accessory module can include a second housing and an integrated power and support plug. The second housing can include a bottom surface. The integrated power and support plug can include electrical contacts. The detachable accessory module can be configured to fit on top of the base monument. The integrated power and support plug can be disposed on the bottom surface of the second housing.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic view of a multi-functional power supply device in accordance with various embodiments herein.

FIG. 2 is a schematic view of a multi-functional power supply device in accordance with various embodiments herein.

FIG. 3 is a schematic view of the interface between a base monument and a detachable accessory module in accordance with various embodiments herein.

FIG. 4 is a schematic perspective view of the top of a base monument in accordance with various embodiments herein.

FIG. 5 is a schematic perspective view of the bottom of a detachable accessory module in accordance with various embodiments herein.

FIG. 6 is a schematic view of the interface between a base monument and a detachable accessory module in accordance with various embodiments herein.

FIG. 7 is a schematic view of a multi-functional power supply device in accordance with various embodiments herein.

FIG. 8 is a schematic view of a multi-functional power supply device in accordance with various embodiments herein.

FIG. 9 is a schematic view of a multi-functional power supply device in accordance with various embodiments herein.

FIG. 10 is a schematic view of a detachable accessory module in accordance with various embodiments herein.

FIG. 11 is a schematic view of a base monument in accordance with various embodiments herein.

FIG. 12 is a schematic view of a component in accordance with various embodiments herein.

FIG. 13 is a schematic view of a component in accordance with various embodiments herein.

FIG. 14 is a schematic view of a component in accordance with various embodiments herein.

FIG. 15 is a schematic front view of a multi-functional power supply device in accordance with various embodiments herein.

FIG. 16 is a schematic top view of a multi-functional power supply device in accordance with various embodiments herein.

FIG. 17 is a schematic side view of a multi-functional power supply device in accordance with various embodiments herein.

FIG. 18 is a schematic view of a component in accordance with various embodiments herein.

FIG. 19 is a schematic view of a component in accordance with various embodiments herein.

FIG. 20 is a schematic view of a component in accordance with various embodiments herein.

FIG. 21 is a schematic view of a component in accordance with various embodiments herein.

FIG. 22 is a schematic view of a component in accordance with various embodiments herein.

FIG. 23 is a schematic view of the interface between a base monument and a detachable accessory module in accordance with various embodiments herein.

FIG. 24 is a schematic view of the interface between a base monument and a detachable accessory module in accordance with various embodiments herein.

FIG. 25 is a schematic view of a multi-functional power supply device in accordance with various embodiments herein.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As described above, a great variety of electronic devices are now commonly being used in many different environments. However, access to electrical power is a common requirement of these devices. Embodiments herein include multi-functional power supply devices that are flexibly adapted to users' specific needs. Specifically, embodiments can include a base monument that can provide power for electronic devices and one or more detachable accessory modules that can provide the user with various accessory functions. The accessory modules can be of many different types, including but not limited to, speaker modules, lighting modules, cap modules, video display modules, battery recharging modules, shelf modules, information input modules, camera modules, multifunction modules, and the like.

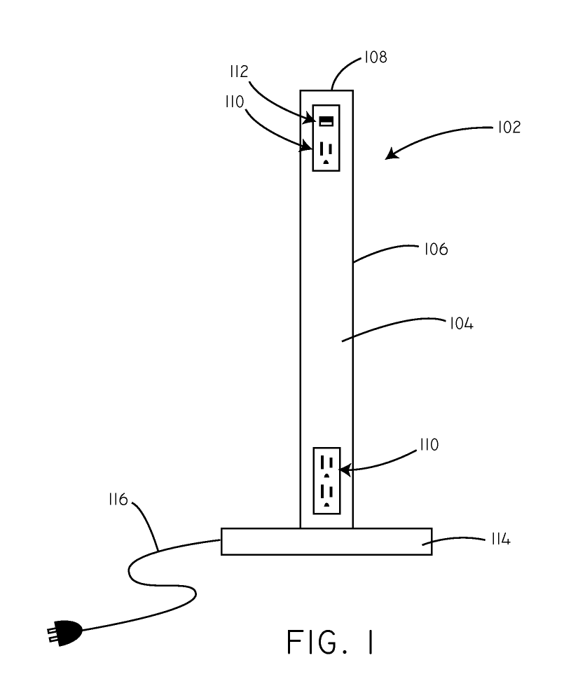

Referring now to FIG. 1, a schematic view of a multi-functional power supply device is shown in accordance with various embodiments herein. The multi-functional power supply device 102 includes a base monument 104. The base monument 104 includes a first housing 106, AC electrical outlets 110, and DC electrical outlets 112. The AC electrical outlets 110 can be disposed on the surface of the first housing. It will be appreciated that the AC and/or DC electrical outlets 110 can be disposed on any side of the first housing. In some embodiments, the AC and/or DC outlets can be disposed on multiple sides of the first housing. The DC electrical outlets 112 can be disposed on the surface of the first housing. The first housing 106 includes a top surface 108. The multi-functional power supply device 102 can include a base platform 114. The base monument 104 can include a power input 116.

The AC and/or DC outlets can be disposed at various heights. In some embodiments, there are outlets at multiple heights (such as near the bottom and/or near the top). In some embodiments, at least some AC and/or DC outlets can be disposed at a height such that they would be from about 21 inches to about 35 inches above the floor or the ground (in the context of a floor standing unit). In some embodiments, at least some AC and/or DC outlets can be disposed at a height such that they would be from about 25 inches to about 31 inches above the floor or the ground (in the context of a floor standing unit). In some embodiments, at least some AC and/or DC outlets can be disposed at a height such that they would be at elbow height when a person is seated in a chair.

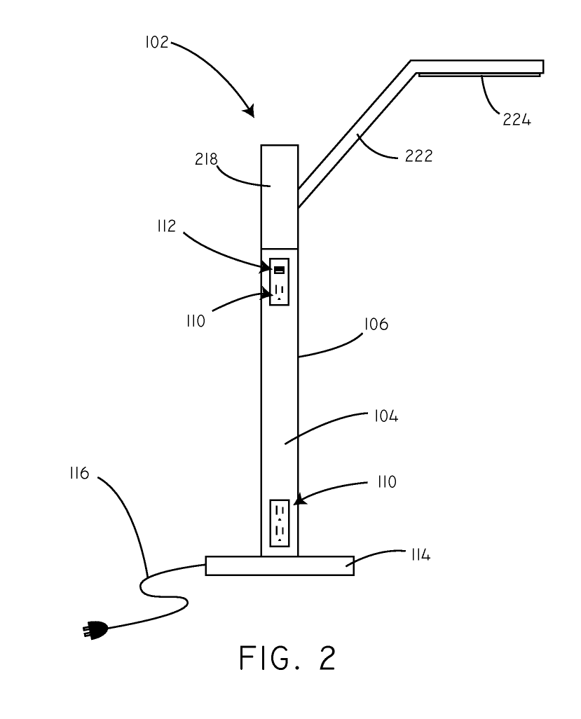

Referring now to FIG. 2, a schematic view of a multi-functional power supply device is shown in accordance with various embodiments herein. The multi-functional power supply device 102 includes a base monument 104 and a detachable accessory module 218. The detachable accessory module 218 can be configured to fit on top of the base monument 104. The base monument 104 includes a first housing 106, AC electrical outlets 110, and DC electrical outlets 112. The base monument 104 can also include power input 116. The detachable accessory module 218 includes a second housing 220. The multi-functional power supply device 102 can include base platform 114. The detachable accessory module 218 can include a cantilevered arm 222. The detachable accessory module 218 can include a light emitter 224.

In some embodiments, the base monument and detachable accessory module(s) can be configured as a floor-standing system. In other embodiments, the base monument and detachable accessory module(s) can be configured to be positioned on a desk. It will be appreciated that the relative heights of features can be adjusted to accommodate these two different use scenarios. In still other embodiments, the base monument and detachable accessory module(s) can be configured to be stacked horizontally instead of vertically.

Referring now to FIG. 3, a schematic view of the interface between a base monument and a detachable accessory module is shown in accordance with various embodiments herein. The base monument (or underlying accessory module) includes a first housing 106 and an integrated power and support socket 326. The socket 326 is an example of an integrated power and support interface. Integrated power and support interfaces can also include integrated power and support plugs. The first housing 106 also includes a top surface 108. The integrated power and support socket 326 includes electrical contacts 328. The detachable accessory module 218 includes a second housing 220 and an integrated power and support plug 330. The integrated power and support plug 330 includes electrical contacts 332. The integrated power and support plug 330 can include a central post 334. Electrical power can be conveyed from one unit (such as a base monument or underlying accessory module) to another unit (such as to an overlying accessory module) through the integrated power and support interface. In some embodiments, power can be conveyed through a direct electrical conduction through electrical contacts. In other embodiments, power can be conveyed through an induction coupling type mechanism.

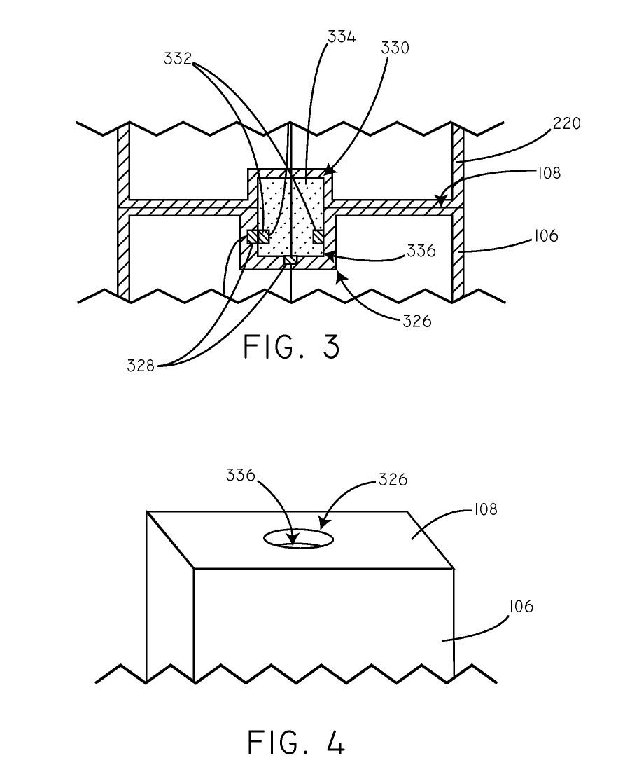

Referring now to FIG. 4, a schematic perspective view of the top of a base monument is shown in accordance with various embodiments herein. The base monument includes a first housing 106 and an integrated power and support socket 326. The first housing 106 includes a top surface 108. The integrated power and support socket 326 can include a central channel 336, into which the central post 334 of the integrated power and support plug 330 fits.

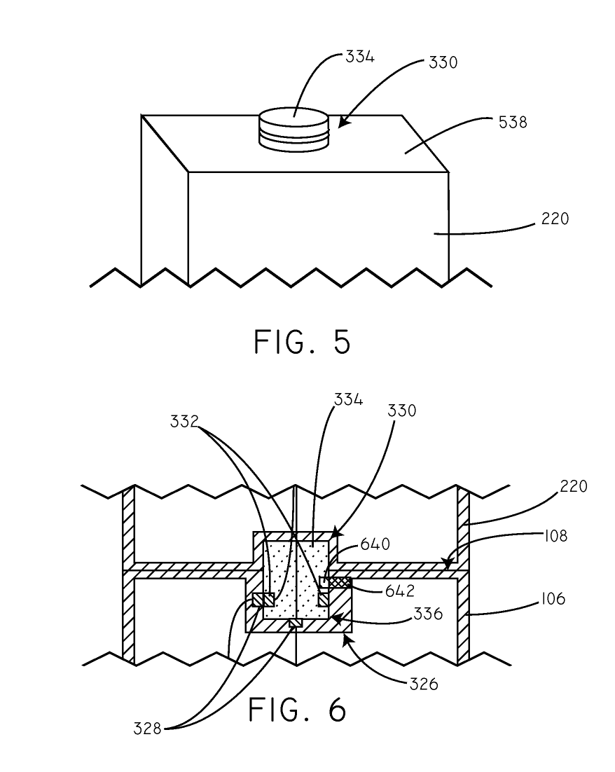

Referring now to FIG. 5, a schematic perspective view of the bottom of a detachable accessory module is shown in accordance with various embodiments herein. The detachable accessory module includes a second housing 220 and an integrated power and support plug 330. The second housing 220 also includes a bottom surface 538. The integrated power and support plug can be disposed on the bottom surface 538 of the second housing 220. The integrated power and support plug 330 can include a central post 334.

Referring now to FIG. 6, a schematic view of the interface between a base monument and a detachable accessory module is shown in accordance with various embodiments herein. The base monument 104 includes a first housing 106 and an integrated power and support socket 326. The first housing 106 includes a top surface 108. The integrated power and support socket 326 includes electrical contacts 328. The detachable accessory module 218 includes a second housing 220 and an integrated power and support plug 330. The integrated power and support plug 330 includes electrical contacts 332. The integrated power and support plug 330 can include a central post 334. The integrated power and support socket 326 can include a central channel 336.

The central post 334 can include a magnet 640, or a similar type of element that can be specifically recognized by a complementary sensor. The multi-functional power supply device 102 can also include a sensor 642 that, in this case, can detect the presence of the magnet when it is in a position adjacent to the sensor 642. However, the sensor 642 can also be configured to detect the presence of the detachable accessory module on top of the base monument in various other ways.

In some embodiments, high voltage electrical current (>100 Volts) is limited to the base monument. For example, electrical current distributed to the detachable accessory module(s) is limited to low voltage power. In some embodiments, the voltage of electrical current distributed to the accessory module(s) through integrated power and support interfaces is less than 80 Volts, or less than 40 Volts, or less than 20 Volts, or less than 15 Volts. In some embodiments, alternating current (AC) electricity is limited to the base monument. In some embodiments, the electrical current distributed to the accessory module(s) from the base monument is only DC.

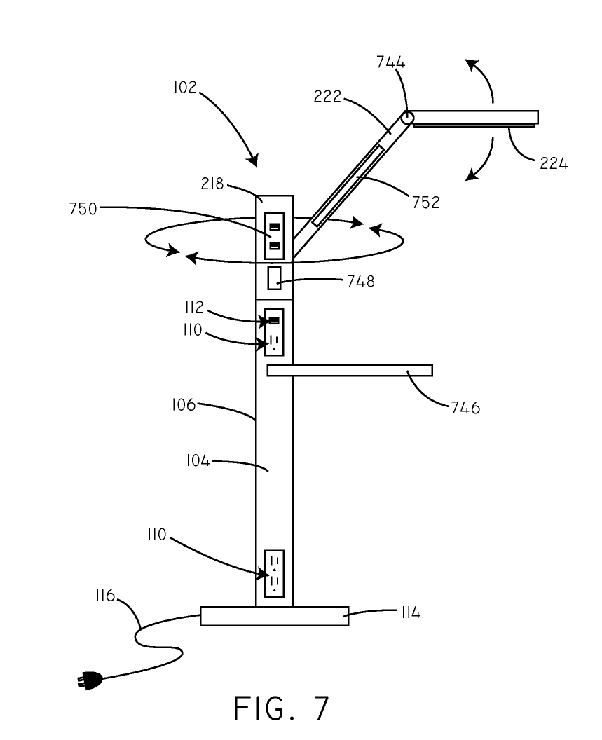

Referring now to FIG. 7, a schematic view of a multi-functional power supply device is shown in accordance with various embodiments herein. The multi-functional power supply device 102 can include a base monument 104 and a detachable accessory module 218. The detachable accessory module 218 can rotate with respect to the base monument 104.

The base monument 104 includes a first housing 106, AC electrical outlets 110, and DC electrical outlets 112. The base monument 104 can include a power input 116.

The detachable accessory module 218 includes a second housing 220. In some embodiments, the multi-functional power supply device 102 can include base platform 114. The detachable accessory module 218 can include a cantilevered arm 222. The detachable accessory module 218 can include light emitter 224.

In some embodiments, the cantilevered arm 222 can include an articulating joint 744. The articulating joint 744 can allow a portion of the cantilevered arm to move in many different directions. In some embodiments, the multi-functional power supply device 102 can include a shelf 746. The detachable accessory module 218 can include a first accessory feature 748. The detachable accessory module 218 can include a second accessory feature 750. The cantilevered arm 222 can include a third accessory feature 752.

It will be appreciated that multi-functional power supply devices in accordance with embodiments herein can be configured with any number of detachable accessory modules. By way of example, multi-functional power supply devices can be configured with between 0 and 6 detachable accessory modules.

In some embodiments, detachable accessory modules can be used separately from other components. By way of example, detachable accessory modules can include their own power supplies (such as a battery) and therefore can operate even when detached from a base monument and/or other detachable accessory modules. In some embodiments, detachable accessory modules can include circuitry to automatically switch to battery power (similar to the power switching function of an uninterruptable power supply (UPS)) when power from the base monument or another accessory module is cut off.

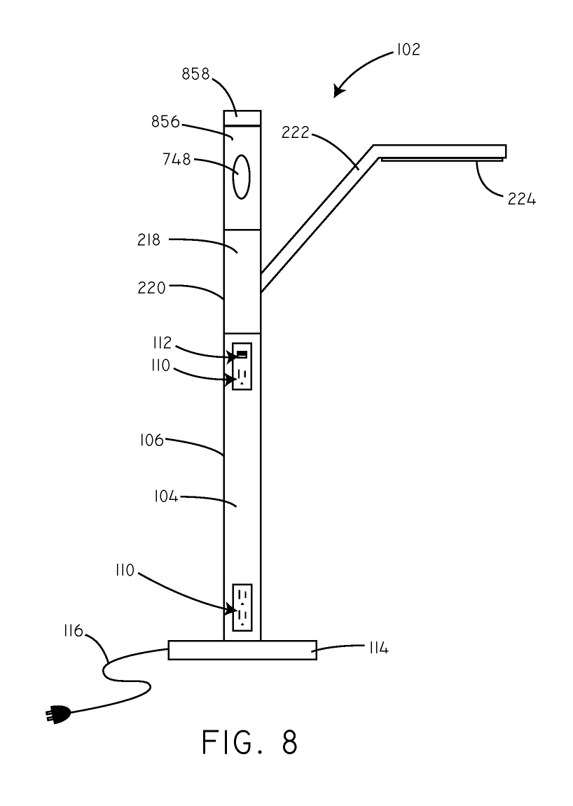

Referring now to FIG. 8, a schematic view of a multi-functional power supply device is shown in accordance with various embodiments herein. The multi-functional power supply device 102 includes a base monument 104 and a detachable accessory module 218. The base monument 104 includes a first housing 106, AC electrical outlets 110, DC electrical outlets 112, and a power input 116. The detachable accessory module 218 includes a second housing 220. The multi-functional power supply device 102 can include a base platform 114. The detachable accessory module 218 can include a cantilevered arm 222. The detachable accessory module 218 can include a light emitter 224. The multi-functional power supply device 102 can also include a second detachable accessory module 854. The second detachable accessory module 854 can include a third housing 856. The detachable accessory module 218 can include a first accessory feature 748. The multi-functional power supply device 102 can also include a cap 858.

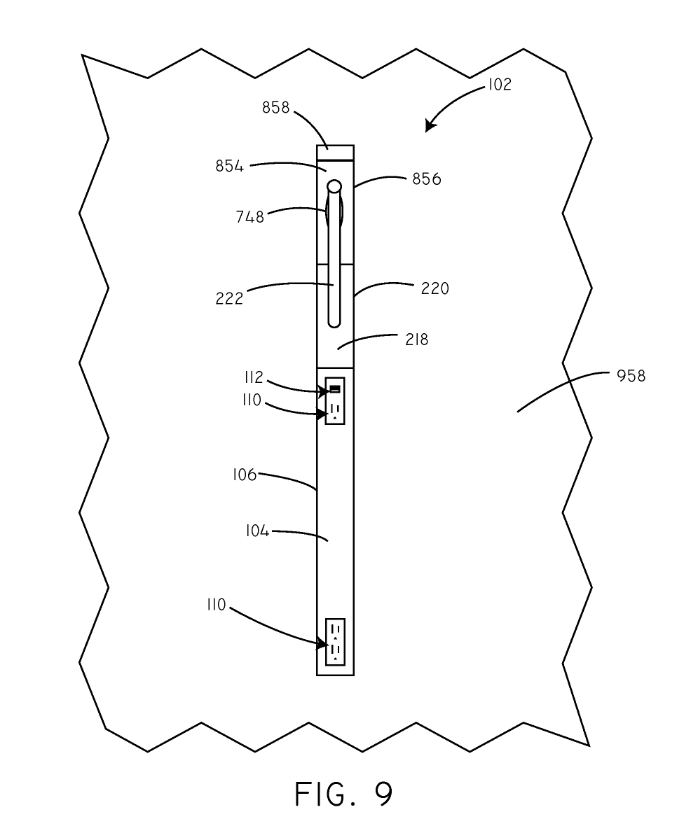

While in some embodiments the multifunctional power supply can be free-standing on a floor, in other embodiments it can be free-standing on a desk, or attached to a wall. Referring now to FIG. 9, a schematic view of a multi-functional power supply device is shown in accordance with various embodiments herein. The multi-functional power supply device 102 includes a base monument 104 and a detachable accessory module 218. The base monument 104 includes a first housing 106, AC electrical outlets 110, and DC electrical outlets 112. The detachable accessory module 218 includes a second housing 220. The detachable accessory module 218 can include cantilevered arm 222. The multi-functional power supply device 102 can include a second detachable accessory module 854. The second detachable accessory module 854 can include third housing 856. The detachable accessory module 218 can include first accessory feature 748. The multi-functional power supply device 102 can include cap 858 that is disposed on top of the second detachable accessory module 854. In this view, the multi-functional power supply device 102 is shown mounted to a wall 958.

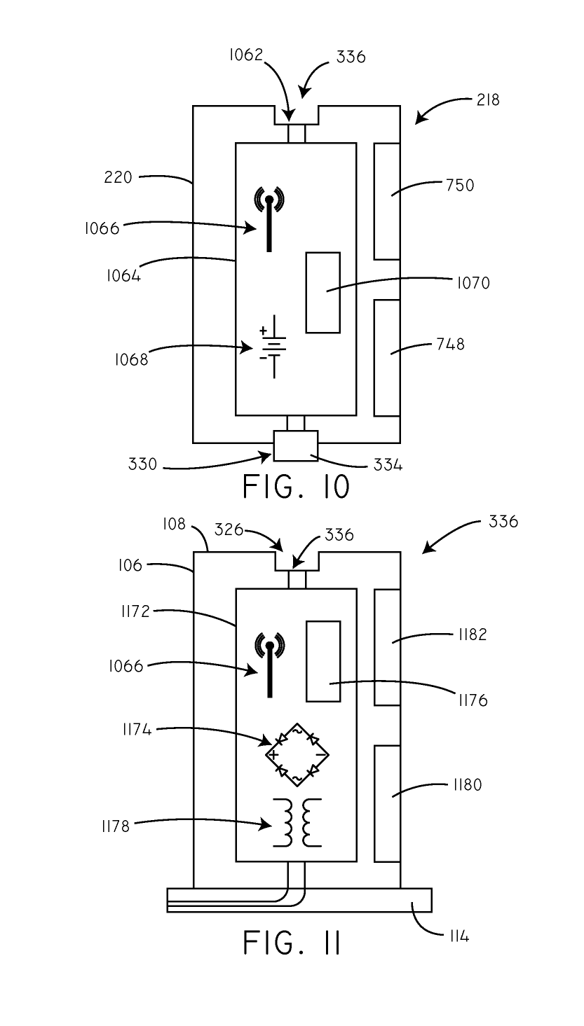

It will be appreciated that base monuments and accessory modules in accordance with embodiments herein can include various elements, including various electronic elements, in order to perform many different functions. Referring now to FIG. 10, the detachable accessory module 218 includes a second housing 220 and an integrated power and support plug 330. The integrated power and support plug 330 can include a central post 334. The detachable accessory module 218 can include a second integrated power and support socket 1062. The detachable accessory module 218 can include internal circuitry 1064. The internal circuitry 1064 can be disposed within the second housing 220. The internal circuitry 1064 can include an emitter and/or receiver 1066. The internal circuitry 1064 can include a battery 1068. The internal circuitry 1064 can include a control circuit 1070. The detachable accessory module 218 can include a first accessory feature 748. The detachable accessory module 218 can also include a second accessory feature 750. The accessory features can include any of those described herein.

Referring now to FIG. 11, the base monument 104 includes a first housing 106, an integrated power and support socket 326, and internal circuitry 1172. The first housing 106 includes a top surface 108. The internal circuitry 1172 can be disposed within the first housing 106. The internal circuitry 1172 can include a rectifier 1174. The rectifier can be disposed within the first housing. The multi-functional power supply device 102 can include a base platform 114 in some embodiments. The integrated power and support socket 326 can include a central channel 336. The internal circuitry 1172 can include a control circuit 1176.

In some embodiments, the control circuit 1176 can be programmable. For example, the control circuit 1176 can include a processor and a memory and can be configured to receive commands that control its operation. For example, the control circuit 1176 can be programmed to power a light emitter with a battery for a predetermined period of time after AC power to the base monument is cut off. Many other operational programs are contemplated herein.

The internal circuitry 1172 can include an emitter and/or receiver 1066. The internal circuitry 1172 can include transformer 1178 in some embodiments. The base monument 104 can include a first base feature 1180. The first base feature 1180 can include, but is not limited to, AC electrical outlets. The base monument 104 can include a second base feature 1182 in some embodiments. The second base feature 1182 can include, but is not limited to, AC and/or DC electrical outlets. In some embodiments, the base features can include any of those described for accessory features herein. In some embodiments, the base monument can specifically include circuitry for one or more of a circuit breaker, a surge protector, and remote control circuitry (such as IR or radiofrequency remote circuitry). In some embodiments, the remote control circuitry can be used to remotely turn on and/or off the multi-functional power supply device or specific components thereof.

As described above, the multi-functional power supply device can include a base platform. The base platform can support the first housing in a vertical orientation. In some embodiments, the base platform can include circular perimeter. In some embodiments, the base platform can include polygonal perimeter. The base platform can be made of many different materials. In some embodiments, the base platform can include a metal. In some embodiments, the base platform can include a polymer.

In some embodiments, connection of the integrated power and support socket with the integrated power and support plug allows for the rotation of the second housing around its lengthwise vertical axis with respect to the first housing.

It will be appreciated that the power and support plug and sockets can take on various forms and include many different elements. In some embodiments, the integrated power and support plug can include a central post. In some embodiments, the central post can include cylindrical shape. However, the central post can have other shapes in some embodiments. The central post can be made of many different materials. In some embodiments, the central post can include a metal. In some embodiments, the central post can include polymer. The integrated power and support socket can include a central channel. The central channel can define a space into which the central post fits. In some embodiments, the central channel defines cylindrical shape

In some embodiments, the central post can include a feature that makes it easier to detect when the post is inserted into the channel of the socket. By way of example, in some embodiments, the central post can include a magnet. In some embodiments, the magnet can include an ALNICO magnet. In some embodiments, the magnet can include a rare earth magnet. The multi-functional power supply device can include a sensor. The sensor can be configured to detect the presence of the second housing on top of the first housing. Many different types of sensors can be used. In some embodiments, the sensor can be a magnetic sensor. In some embodiments, the sensor selected from the group consisting of Hall effect sensor, magneto transistor, flux-gate sensor, magnetodiode, magneto-optical sensor, and magneto resistive sensor.

The internal circuitry of the base monument can include a control circuit. The control circuit can be configured to provide power to the integrated power and support socket only when the sensor detects the presence of the second housing on top of the first housing. The internal circuitry can include an emitter and/or receiver. The emitter and/or receiver can include a wireless signal emitter selected from the group consisting of an infrared light emitter, and a radiofrequency emitter. The emitter and/or receiver can include a wireless signal receiver selected from the group consisting of an infrared light receiver, and a radiofrequency receiver.

In various embodiments, the detachable accessory module includes a cantilevered arm. In some embodiments, the cantilevered arm can rotate with respect to the second housing. The cantilevered arm can be formed of many different materials. In some embodiments, the cantilevered arm can include metal. In some embodiments, the cantilevered arm can include polymer. In some embodiments, the cantilevered arm can be oriented upward. The detachable accessory module can include a light emitter. In some embodiments, the light emitter selected from the group consisting of LED light, an incandescent light, and a fluorescent light. In some embodiments, the light emitter is disposed on the cantilevered arm.

The multi-functional power supply device can include a shelf in some embodiments. The shelf can be attached to the second housing. In some embodiments, the shelf can include an induction coupling interface. The detachable accessory module can include a second integrated power and support socket. The second integrated power and support socket can include electrical contacts. In some embodiments, the second integrated power and support socket is disposed on top of the second housing.

The multi-functional power supply device can include a second detachable accessory module. The second detachable accessory module can be configured to fit on top of the first detachable accessory module. The detachable accessory module can include internal circuitry. The internal circuitry can be disposed within the second housing. The internal circuitry can include an emitter and/or receiver, similar to as described above. The internal circuitry can include a battery. The internal circuitry can include a control circuit

In some embodiments, the control circuit causes the emitter and/or receiver to emit light for a predefined time period after power to the detachable accessory module is disconnected. In some embodiments, the accessory module includes a touch sensor and the time period is reset upon a touch sensor indicating that the detachable accessory module has been touched.

In some embodiments, the accessory module and/or the base monument can include voice initiation of functions and/or transmission of voice communications. As an example, the accessory module and/or the base monument can include an emergency alert function that can be voice-activated. In such an embodiments, an individual within proximity of the system can initiate an emergency mode using a voice command which can trigger various actions such as dialing of a predetermined number or sending an emergency alert through a communication network. In some embodiments, a key fob can be included that can trigger the emergency mode. In some embodiments, microphones and speakers can be used to provide for an intercom function between different locations within a dwelling or other type of environment. For example, in such embodiments, the system can record sound in a first location (with a first base monument or accessory module) and then transport sound data through a data transmission network (such as a WIFI network) to a second location (such as to a second base monument or a second accessory module) and then reproduce the sound using a speaker.

The detachable accessory module can include a first accessory feature. In some embodiments, the first accessory feature can be selected from the group consisting of an LED light, an LCD panel or display, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet, a camera (still or video), a temperature sensor, proximity sensor, occupancy sensor, motion sensor, a WIFI hub, an emergency alert button, a Bluetooth communications module, and an induction coupling interface. In some embodiments, the first accessory feature can include touch sensor.

The detachable accessory module can include a second accessory feature. In some embodiments, the second accessory feature can be selected from the group consisting of an LED light, an LCD panel or display, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet, a camera (still or video), a temperature sensor, proximity sensor, occupancy sensor, motion sensor, a WIFI hub, an emergency alert button, a Bluetooth communications module, and an induction coupling interface. In some embodiments, the second accessory feature can include DC outlet.

In some embodiments, the cantilevered arm can include a third accessory feature. In some embodiments, the third accessory feature can be selected from the group consisting of an LED light, an LCD display or panel, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet, a camera (still or video), a temperature sensor, proximity sensor, occupancy sensor, motion sensor, a WIFI hub, an emergency alert button, a Bluetooth communications module, and an induction coupling interface. In some embodiments, the third accessory feature can include touch sensor.

In various embodiments, the multi-functional power supply device can include a cap. The cap can include a plug that fits into the socket on the base monument and/or any of the accessory modules. The plug of the cap can be configured to indicate to the base monument that power should be delivered up through the accessory modules.

The base monument can include a first base feature. In some embodiments, the first base feature can be selected from the group consisting of an LED light, an LCD display or panel, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet (AC and/or DC), and an induction coupling interface for power transmission to an accessory module or to a user device such as a phone.

The base monument can include a second base feature in some embodiments. The second base feature can be selected from the group consisting of an LED light, an LCD display or panel, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet (AC and/or DC), and an induction coupling interface for power transmission to an accessory module or to a user device such as a phone.

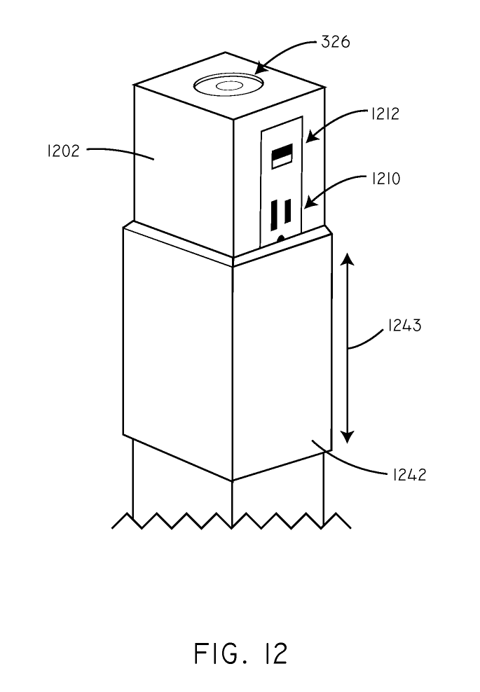

In some embodiments, the multi-functional power supply device can include a sliding cover. Referring now to FIG. 12, a schematic view of a component in accordance with various embodiments herein. As shown in this view, a component 1202 (which can be either a base monument or a detachable accessory module) can include AC electrical outlets 1210 and/or DC electrical outlets 1212 and an integrated power and support socket 326. The component 1202 can also include a sliding cover 1242. The sliding cover 1242 can move up and down in the direction of arrow 1243. In this manner, the sliding cover 1242 can be used to obscure one or more features such as the AC electrical outlets 1210 and/or DC electrical outlets 1212. In some embodiments, the component 1202 housing can include a channel in order to accommodate a portion of the sliding cover 1242 such as a pin, post, or projection fitting therein. Then, the sliding cover 1242 can move up and down with the pin, post, or projection moving within the channel. In some embodiments, the sliding cover 1242 can lock in either a fully closed or fully open position.

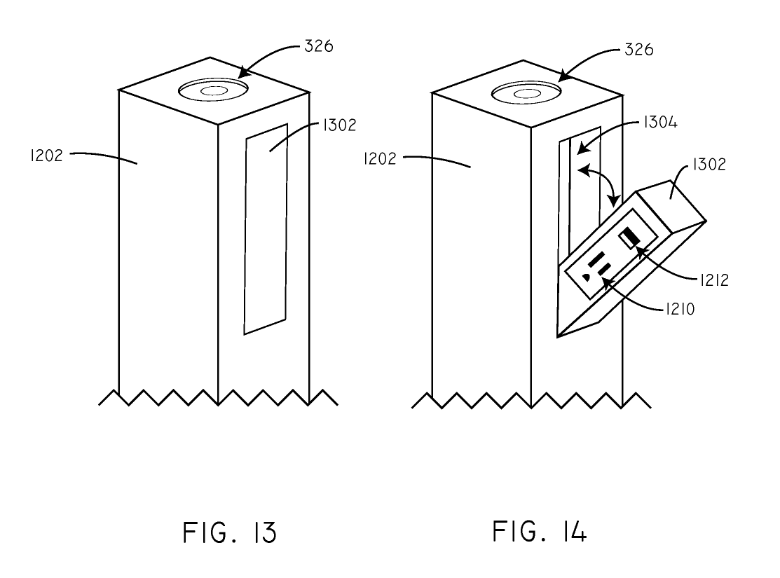

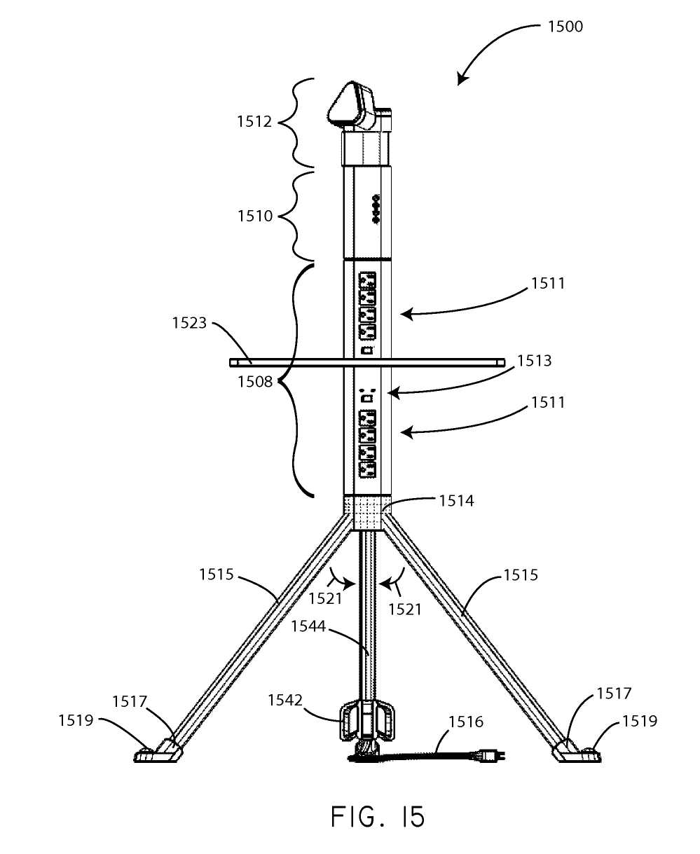

Referring now to FIG. 13, a schematic view of a component in accordance with various embodiments herein. As shown in this view, a component 1202 (which can be either a base monument or a detachable accessory module) can include an integrated power and support socket 326 and an accessory arm 1302. Referring now to FIG. 14, a schematic view of a component is shown in accordance with various embodiments herein. As shown in FIG. 14, the accessory arm 1302 can pivot out from a compartment 1304 within the component 1202 into an open position exposing one or more features such as the AC electrical outlets 1210 and/or DC electrical outlets 1212. When the accessory arm 1302 is in a closed position, it can be completely disposed within the compartment 1304. The accessory arm can include an element such as a pivoting joint, an axle, a hinge, or the like in order to facilitate pivoting. In some embodiments, the element that facilitates pivoting can be dampened in order to control the rate at which the accessory arm 1302 is opened or closed. In some embodiments, the accessory arm 1302 can move out laterally instead of pivoting.

Referring now to FIG. 15, a schematic front view of a multi-functional power supply device 1500 is shown in accordance with various embodiments herein. The device 1500 can include various components that can be separable from one another. By way of example, the device 1500 can include a base platform 1514. The base platform 1514 can include one or more legs 1515. In some embodiments, the base platform 1514 can include three legs 1515. The legs 1515 can include feet 1517 for contacting a support surface such as the ground or a floor. The legs 1515 can vary in length. In some embodiments, the legs can be from about 8 inches to about 36 inches. In some embodiments, the legs can be from about 15 inches to about 28 inches.

In some embodiments, the feet 1517 can include an attachment aperture 1519. The attachment aperture 1519 can be a hole or a slot that can accommodate a device such as a nail or a screw passing through the attachment aperture 1519 and into a support surface in order to secure the feet 1517 thereto. In some embodiments, the legs 1515 can fold inward in the direction of arrows 1521.

In some embodiments, the base platform 1514 can include cord guide 1542 mounted on an extension shaft 1544. The cord guide 1542, in conjunction with the extension shaft 1544, can serve to lower the point at which force is applied to the multi-functional power supply device 1500 if the power cord 1516 is pulled on. In some embodiments, the extension shaft 1544 can be adjustable so that the height of the cord guide 1542 can be adjusted as desired. The extension shaft 1544 can include a lumen therein in order to accommodate the passage of electrical wire or other components therein.

The cord guide 1542 in combination with the extension shaft 1544 can vary in length. In some embodiments, the cord guide 1542 in combination with the extension shaft 1544 can be from about 8 inches to about 33 inches. In some embodiments, the cord guide 1542 in combination with the extension shaft 1544 can be from about 15 inches to about 25 inches.

In some embodiments, the cord guide 1542 can be rotatable such that if the power cord 1516 is pulled from a particular direction the cord guide 1542 will rotate to orient itself to face in that direction. In some embodiments, the cord guide 1542 can include slots or channels therein to receive the legs 1515 when they are folded inward.

The multi-functional power supply device 1500 can include a base monument 1508 that is disposed on the base platform 1514. The multi-functional power supply device 1500 can include a first detachable accessory module 1510 and a second detachable accessory module 1512.

The base monument 1508 can include AC electrical outlets 1511 and/or DC electrical outlets 1513. The base monument 1508 can also include a shelf 1523. While not shown in this view, it will be appreciated that the base monument 1508 can also include other elements including, but not limited to, any of the accessory features described above.

The first detachable accessory module 1510 can include one or more elements including, but not limited to, any of the accessory features described above. In a particular embodiment, the first detachable accessory module 1510 includes a speaker that can receive wireless signals such as a Bluetooth enabled speaker module. In some embodiments, the speaker module can also include a battery to allow the module to continue to operate even if the accessory module is unplugged or power to the system is cut off.

In a particular embodiment, the detachable accessory module can include a light and a battery. The light can include a power switching circuit and be configured to turn on automatically and emit light from the power stored in the battery if power to the accessory module is cut off.

In various embodiments, the base monument and/or accessory modules can include proximity sensors and/or motion sensors to detect when an individual is nearby. In some embodiments, the system can be configured to take a particular action when a person is detected nearby, such as turning on or flashing a light. In other embodiments, the system can store the information regarding proximity and the timing thereof to an internal memory module that can be part of the control circuitry. The system can later be interrogated to retrieve this stored data.

In various embodiments, the base monument and/or the accessory module(s) can function as an occupancy sensor. By way of example, a proximity sensor and/or motion sensor can be used in determine when someone is occupying a room (such as a conference room or the like). If at least a threshold amount of activity is sensed by a proximity and/or motion sensor, then the room can be deemed to be occupied. If no activity is recorded for at least a threshold amount of time, then the room can be deemed to be unoccupied. The thresholds for activity and the passage of time can have a default value and can then be configured by a system user. In some embodiments, data regarding occupancy of a room can be sent across a communication network, such as a WIFI network, to a server or a remote computer for further use.

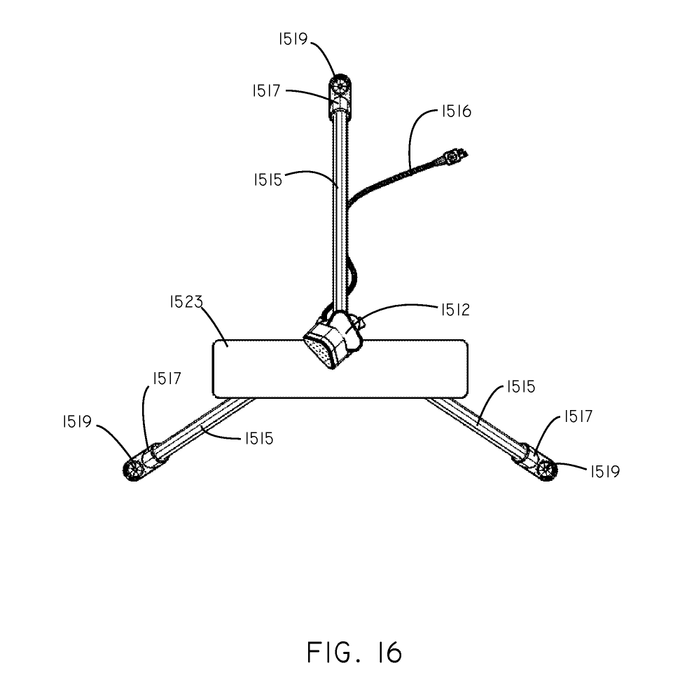

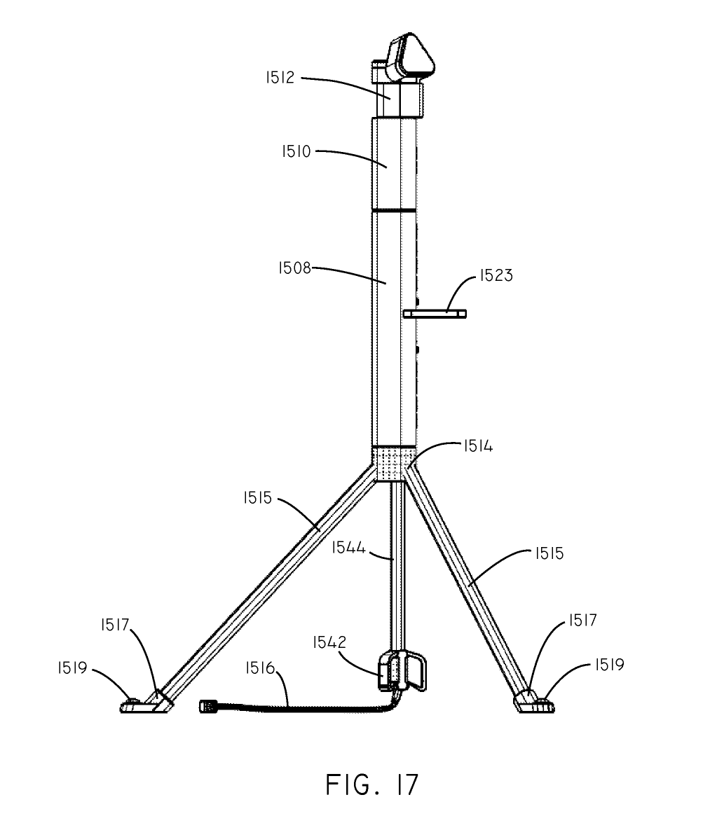

The second detachable accessory module 1512 can include one or more elements including, but not limited to, any of the accessory features described above. In a particular embodiment, the second detachable accessory module 1512 includes a light. In various embodiments the light can be mounted so as to rotate with respect to the accessory module. In some embodiments, the light accessory module can further include a motor to rotate the light on the accessory module. Referring now to FIG. 16, a schematic top view of the multi-functional power supply device 1500 is shown in accordance with various embodiments herein. Referring now to FIG. 17, a schematic side view of the multi-functional power supply device 1500 is shown in accordance with various embodiments herein.

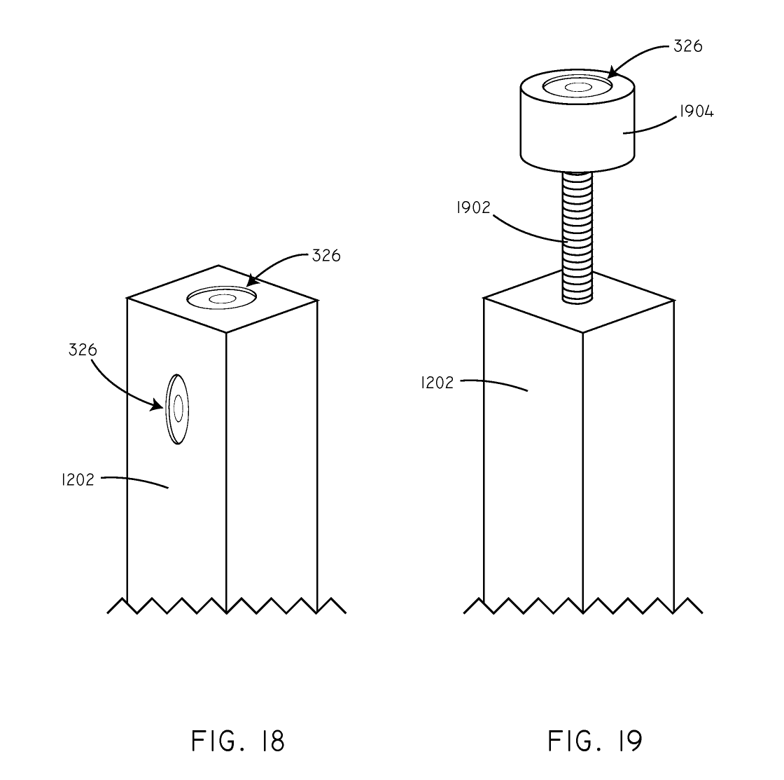

It will be appreciated that integrated power and support sockets and integrated power and support plugs can be disposed on various surfaces on the housing of base monuments and/or accessory modules. By way of example, integrated power and support sockets and/or integrated power and support plugs can be disposed on the top, bottom, and/or sides (front, back, left, and/or right) of base monuments and/or accessory modules. Referring now to FIG. 18, a component 1202 (such as a base monument or an accessory module) is shown in accordance with various embodiments herein. The component 1202 can include one or more integrated power and support sockets 326. In this example, one of the integrated power and support sockets 326 can be disposed on the top of the component 1202 while the other can be disposed on the side of the component 1202. In some embodiments, the integrated power and support socket 326 shown on the top of the component 1202 can be omitted and an integrated power and support socket 326 is disposed only on the side.

In some embodiments, an articulating joint can be included. In some embodiments, the articulating joint can allow an integrated power and support socket, an integrated power and support plug, accessory feature, and/or base feature to be positioned at various angles with respect to the component (base monument or accessory module) to which the articulating joint is attached. Referring now to FIG. 19, a component 1202 (such as a base monument or an accessory module) is shown in accordance with various embodiments herein. In this view, an articulating joint 1902 is disposed on the top of the component 1202. In some embodiments, an articulating joint 1902 can be disposed on the side (front, back, left, and/or right) of the component 1202. The articulating joint 1902 can be connected to an articulating platform 1904 which can have an integrated power and support socket 326 (or integrated power and support plug or a base or accessory feature) disposed thereon.

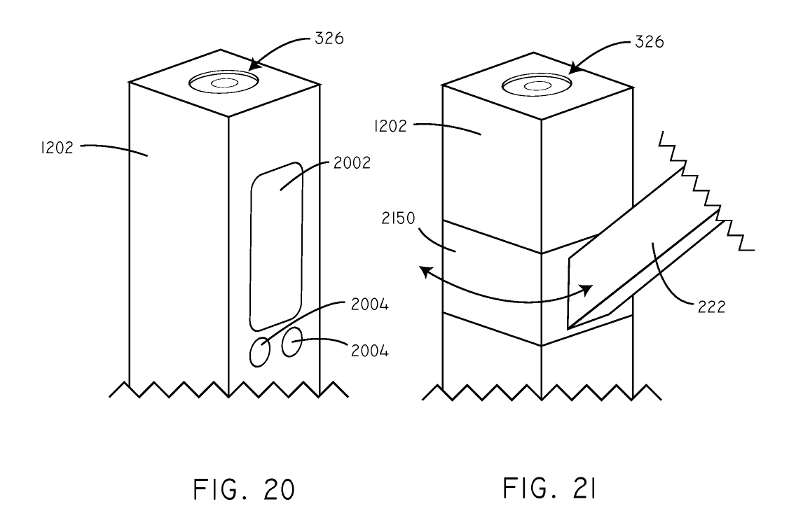

FIG. 20 is a schematic view of a component in accordance with various embodiments herein. As shown in this view, a component 1202 (which can be either a base monument or a detachable accessory module) can include an integrated power and support socket 326 and a video display 2002 (such as an LCD panel or display) and one or more interface buttons 2004. The device can be configured to display various pieces of information on the video display 2002. For example, information can include one or more of current weather conditions, future weather conditions, information regarding music being played, the current time and/or date, or the like.

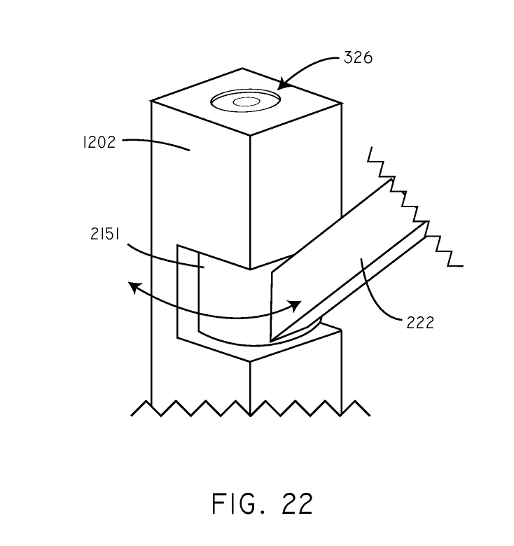

In some embodiments, such as illustrated in FIG. 7, detachable accessory modules 218 can rotate with respect to the base monument 104. However, in other embodiments, the detachable accessory modules can be stationary with respect to the module or base monument underneath them but a component disposed on the detachable accessory module can rotate. Referring now to FIG. 21 is a schematic view of a component in accordance with various embodiments herein. A component 1202 (which can be either a base monument or a detachable accessory module) can include a cantilevered arm 222. The arm 222 can be attached to a rotatable component segment 2150. In some embodiments, the rotatable component segment 2150 can define a central lumen through which a connecting shaft of the component 1202 can pass. The rotatable component segment 2150 can rotate about the central lumen. As such, the arm 222 and any elements attached to the arm 222 (such as a lighting source) can rotate with respect to the component without rotating the entire component 1202 itself. Referring now to FIG. 22 a schematic view is shown of a component in accordance with various embodiments herein. A component 1202 (which can be either a base monument or a detachable accessory module) can include a cantilevered arm 222. The arm 222 can be attached to a rotatable cylindrical segment 2151 (an example of a rotatable component segment). The rotatable cylindrical segment 2151 can rotate independently from the rest of the component. As such, the arm 222 and any elements attached to the arm 222 (such as a lighting source) can rotate with respect to the component without rotating the entire component 1202 itself.

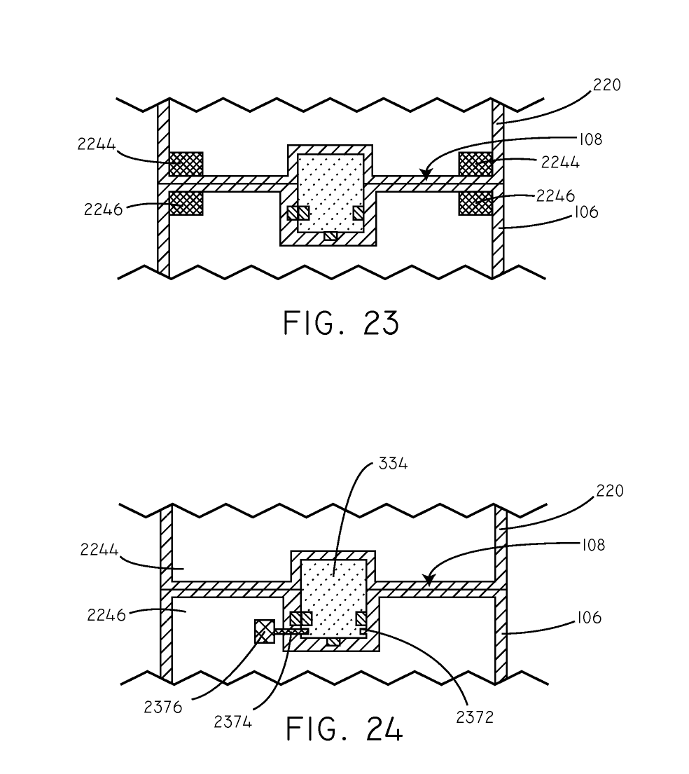

In some embodiments, the basement monument and the accessory modules can be configured so that they align with one another in a particular way. This can be accomplished in various ways. In some embodiments, magnets can be used to provide for alignment between the base monument and accessory modules or between one accessory module and a second accessory module. Referring now to FIG. 23, a schematic view of the interface between a base monument (or underlying accessory module) and a detachable accessory module is shown in accordance with various embodiments herein. The base monument (or underlying accessory module) includes a first housing 106 and an integrated power and support socket. The first housing 106 also includes a top surface 108. The detachable accessory module includes a second housing 220 and an integrated power and support plug. One or more first alignment magnets (2246) can be disposed on or within the first housing 106 and one or more second alignment magnets (2244) can be disposed on or within the second housing 220. The first alignment magnets can interface with the second alignment magnets in order to cause the first housing 106 and the second housing 220 to align with one another in a particular orientation. For example, in the context of housings that are square in cross-section, the magnets can be oriented so that the first housing 106 and the second housing preferentially align with on another so that the flat faces.

In some embodiments, the base monument and the accessory modules can be configured so that they can be locked to one another. For example, a locking mechanism can be included to lock the base monument to the accessory module. This can be accomplished in various ways. Referring now to FIG. 24, a schematic view of the interface between a base monument (or underlying accessory module) and a detachable accessory module is shown in accordance with various embodiments herein. The base monument (or underlying accessory module) includes a first housing 106 and an integrated power and support socket. The first housing 106 also includes a top surface 108. The detachable accessory module includes a second housing 220 and an integrated power and support plug 330. The integrated power and support plug 330 can include a central post 334. In some embodiments the central post 334 can define a channel 2372 around the outer perimeter thereof. A locking pin 2374 can fit within the channel 2372 and can be moved into and out of the channel with an actuator 2376. When the locking pin 2374 is engaged within the channel 2372 the central post 334 can still be rotated, but the first housing 106 and the second housing 220 cannot be separated from one another.

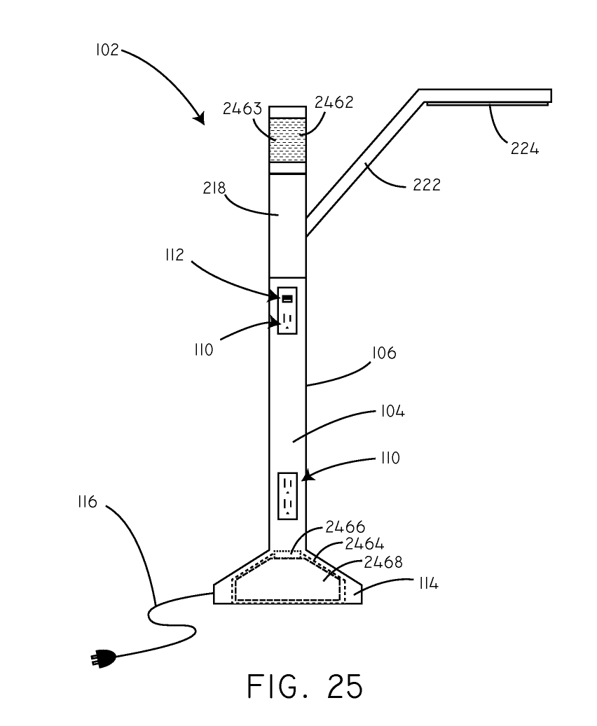

In some embodiments, an accessory module can be fitted into the base platform 114 of the base monument. Referring now to FIG. 25, a schematic view is shown of a multi-functional power supply device in accordance with various embodiments herein. The multi-functional power supply device 102 includes a base monument 104 and a detachable accessory module 218. The detachable accessory module 218 can be configured to fit on top of the base monument 104. The base monument 104 includes a first housing 106, AC electrical outlets 110, and DC electrical outlets 112. The base monument 104 can also include power input 116. The detachable accessory module 218 includes a second housing 220. The multi-functional power supply device 102 can include base platform 114. The detachable accessory module 218 can include a cantilevered arm 222. The detachable accessory module 218 can include a light emitter 224. A second detachable accessory module 2462 can be disposed on top of the first detachable accessory module 218. The second detachable accessory module 2462 can include a speaker 2463, such as a Bluetooth speaker. The base platform 114 of the base monument can define an interior cavity 2464. A connection port 2466 can be disposed at the top of the interior cavity 2464. The connection port 2466 can provide for electrical contacts (power and/or data) to connect with other components of the system. A speaker module 2468, such as a low frequency speaker module or subwoofer, can be disposed within the interior cavity 2464.

In some embodiments, a kit is included that includes multiple multi-functional power supply devices. The multiple devices can be networked to one another. In an embodiment, they can exchange location coordinates with one another.

It should be noted that, as used in this specification and the appended claims, the singular forms ‘a,’ ‘an,’ and ‘the’ include plural referents unless the content clearly dictates otherwise. Thus, for example, reference to a composition containing ‘a compound’ includes a mixture of two or more compounds. It should also be noted that the term ‘or’ is generally employed in its sense including ‘and/or’ unless the content clearly dictates otherwise.

It should also be noted that, as used in this specification and the appended claims, the phrase ‘configured’ describes a system, apparatus, or other structure that is constructed or configured to perform a particular task or adopt a particular configuration to. The phrase ‘configured’ can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A multi-functional power supply device comprising:
a base monument comprising
a first housing comprising a top;
a first integrated power and support interface comprising electrical contacts, the interface disposed on top of the first housing;
a rectifier disposed within the first housing;
one or more AC electrical outlets disposed on the surface of the first housing;
one or more DC electrical outlets disposed on the surface of the first housing; and
a detachable accessory module configured to fit on top of the base monument; the detachable accessory module comprising
a second housing;
a second integrated power and support interface comprising electrical contacts, the plug disposed on the bottom of the second housing;
wherein engagement of the first integrated power and support interface with the second integrated power and support interface allows for the transmission of electricity between the first housing and the second housing and provides structural support sufficient to prevent the second housing from moving laterally with respect to the first housing.

2. The multi-functional power supply device of claim 1, the first integrated power and support interface comprising an integrated power and support socket.

3. The multi-functional power supply device of claim 1, the second integrated power and support interface comprising an integrated power and support plug.

4. The multi-functional power supply device of claim 1, further comprising a base platform, the base platform supporting the first housing in a vertical orientation.

5. The multi-functional power supply device of claim 4, the base platform defining an interior cavity, the base monument further comprising a speaker module disposed within the interior cavity.

5. The multi-functional power supply device of claim 1, wherein the connection of the integrated power and support socket with the complementary power and support plug allows for the rotation of the second housing around its lengthwise vertical axis with respect to the first housing while maintaining an electrical connection for the transmission of electricity between the first housing and the second housing.

6. The multi-functional power supply device of claim 3, wherein the integrated power and support plug comprises a central post, the integrated power and support socket comprising a central channel into which the central post fits.

7. The multi-functional power supply device of claim 5, the central post comprising a magnet.

8. The multi-functional power supply device of claim 1, further comprising a first alignment magnet connected to a top portion of the first housing and a second alignment magnet connected to a bottom portion of the second housing, the first alignment magnet configured to interface with the second alignment magnet to align the first housing with the second housing in a particular orientation.

9. The multi-functional power supply device of claim 1, the detachable accessory module further comprising a rotatable component segment that rotates about a lengthwise vertical axis of the second housing independently of the detachable accessory module.

10. The multi-functional power supply device of claim 1, further comprising a locking mechanism to lock the base monument to the detachable accessory module.

11. The multi-functional power supply device of claim 1, further comprising a sensor configured to detect the presence of the second housing on top of the first housing, and a power control circuit, wherein the power control circuit is configured to provide power to the integrated power and support interface only when the sensor detects the presence of the second housing on top of the first housing.

12. The multi-functional power supply device of claim 11, the sensor comprising a sensor selected from the group consisting of a Hall effect sensor, magneto transistor, flux-gate sensor, magnetodiode, magneto-optical sensor, and magneto resistive sensor.

13. The multi-functional power supply device of claim 1, the detachable accessory module comprising an electrical element selected from the group consisting of: an LED light, an LCD display, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet, and an induction coupling interface.

14. The multi-functional power supply device of claim 13, the wireless signal emitter selected from the group consisting of an infrared light emitter, and a radiofrequency emitter.

15. The multi-functional power supply device of claim 13, the wireless signal receiver selected from the group consisting of an infrared light receiver, and a radiofrequency receiver.

16. The multi-functional power supply device of claim 1, the detachable accessory module comprising a cantilevered arm and comprising a light selected from the group consisting of an LED light, an incandescent light, and a fluorescent light, the light disposed on the cantilevered arm.

17. The multi-functional power supply device of claim 1, the detachable accessory module of claim 11, wherein the cantilevered arm comprises an articulating joint.

18. The multi-functional power supply device of claim 1, the detachable accessory module of claim 11, wherein the cantilevered arm can rotate with respect to the second housing.

19. The multi-functional power supply device of claim 1, further comprising a shelf attached to the first housing.

20. The multi-functional power supply device of claim 19, the shelf comprising an induction coupling interface.

21. The multi-functional power supply device of claim 1, further comprising a shelf attached to the second housing.

22. The multi-functional power supply device of claim 21, the shelf comprising an induction coupling interface.

23. The multi-functional power supply device of claim 1, the detachable accessory module further comprising a second integrated power and support socket comprising electrical contacts, the second socket disposed on top of the second housing.

24. The multi-functional power supply device 1, further comprising a second detachable accessory module, the second detachable accessory module configured to fit on top of the first detachable accessory module; the second detachable accessory module comprising a third housing and a second integrated power and support plug comprising electrical contacts, the second plug disposed on the bottom of the third housing.

25. The multi-functional power supply device 1, the detachable accessory module comprising a light emitter, a battery, and a timer circuit, wherein the timer circuit causes the light emitter to emit light for a predefined time period after power to the detachable accessory module is disconnected.

26. The multi-functional power supply device 25, the detachable accessory module further comprising a touch sensor, wherein the timer circuit causes the light emitter to emit light for a predefined time period after power to the detachable accessory module is disconnected, wherein the time period is reset upon the touch sensor indicating that the detachable accessory module has been touched.

27. The multi-functional power supply device of claim 1, further comprising a base platform, the base platform comprising a plurality of legs, wherein the legs are configured to fold together.

28. The multi-functional power supply device of claim 27, the base platform further comprising an extension shaft connected the base platform and a cord guide connected to the extension shaft, the extension shaft disposed between the plurality of legs.

29. The multi-functional power supply device of claim 27, the cord guide configured to rotate.

30. The multi-functional power supply device of claim 1, wherein at least one of the base monument and the detachable accessory module further comprise a sliding cover.

31. The multi-functional power supply device of claim 1, further comprising an accessory arm, wherein the accessory arm is configured to pivot outward from the base monument.

32. A kit comprising:
a base monument comprising
a first housing comprising a top;
an integrated power and support socket comprising electrical contacts, the socket disposed on top of the first housing;
a rectifier disposed within the first housing;
one or more AC electrical outlets disposed on the surface of the first housing;
one or more DC electrical outlets disposed on the surface of the first housing; and
a detachable accessory module comprising
a second housing;
an integrated power and support plug comprising electrical contacts, the plug disposed on the bottom of the second housing; and
an electrical element selected from the group consisting of: an LED light, an LCD display, an incandescent light, a fluorescent light, a speaker, a microphone, a wireless signal emitter, a wireless signal receiver, a wireless networking circuit, a touch sensitive interface, a data input device, a battery, a battery charger, an antenna, an electrical outlet, and an induction coupling interface.
